(19) United States
(12) Patent Application Publication
(10) Pub. No.: US 2025/0321551 A1
(43) Pub. Date: Oct. 16, 2025

(54) SYSTEM AND METHOD FOR SEQUENTIAL SYSTEM IDENTIFICATION IN CHILLED WATER PLANTS USING BAYESIAN INFERENCE

(71) Applicants: CARTER HOWE, SAINT JOHN (CA); SCOTT MCDONALD, MONTREAL (CA)

(72) Inventors: CARTER HOWE, SAINT JOHN (CA); SCOTT MCDONALD, MONTREAL (CA)

(21) Appl. No.: 19/174,197

(22) Filed: Apr. 9, 2025

Related U.S. Application Data
(60) Provisional application No. 63/633,278, filed on Apr. 12, 2024.

(51) Int. Cl. G05B 13/04; G05B 13/02

(52) U.S. Cl. CPC G05B 13/042; G05B 13/0265

(57) ABSTRACT

Predictive methods such as machine learning methods based on neural network technology require large sets of historical training data that are often not available or may not represent the required range of operating scenarios, seasons etc. Accordingly, deployment of machine learning may be impeded or delayed while suitable training data is collected. Further, the characteristics of the plant and its component may change over time due to wear and tear, maintenance events, equipment replacement or upgrades such that the predictive models must be updated (re-trained). Determining an effective schedule for such re-training and the re-training process introduces additional costs, as well as the risk that seasonality and other variables may not be properly captured in the process of re-training these models. Accordingly, it would be beneficial to provide methods and system that mitigate these obstacles with respect to the commercial application of machine-learning and other predictive methods.

### CROSS-REFERENCE TO RELATED APPLICATIONS

This patent application claims the benefit of priority to U.S. Provisional Patent Application 63/633,278 filed Apr. 12, 2024; the entire contents of which are incorporated herein by reference.

### FIELD OF THE INVENTION

This patent application relates to chilled water plant and more particularly to the control of chilled water plant.

### BACKGROUND OF THE INVENTION

Chilled water plants are widely used to remove heat from water which in turn is applied to cool various manufacturing processes and to cool the interior spaces of large data centers, hospitals, office towers, airport terminals, shopping malls, hotels and other buildings. These plants comprise an interconnected system of pumps, cooling towers, heat exchangers, compressors, plumbing, sensors and controls that represent large capital investments which must be operated and maintained over an expected lifetime often exceeding 20 years.

Various technologies have been developed to aid in the operation and maintenance of these plants: these technologies include automatic control systems, performance monitoring systems, fault detection, and diagnostic systems. More recently, it has been recognized that predictive methods represent an opportunity to further improve the efficiency, performance, and useful life of chilled water plants and to improve the maintenance of these plants.

However, chilled water plants present a number of barriers to the commercial application of predictive methods. These barriers include that a large number of (e.g., 30-150) predictive models may be required to properly model the performance, efficiency, and fault status of chilled water plants. For each plant each of these models must be selected, defined, generated, trained, tested, and integrated together. Without a high level of automation this is a complex, costly process which requires skills and expertise that are not generally available in the workforce that supports chilled water plants.

Predictive methods such as machine learning methods based on neural network technology require large sets of historical training data that are often not available for chilled water plants. The available data may not represent the required range of operating scenarios and data may not be available for each season due to the lack of data logging. Because Machine Learning requires training data that is often not available for the individual chiller plant, deployment of Machine Learning may be impeded or delayed while suitable training data is collected. The time needed for the collection of this training data may delay the business benefits of predictive methods.

Over time, the characteristics of the plant and its component may change due to wear and tear, maintenance events, equipment replacement or upgrades. Predictive models must be updated (re-trained) to accurately reflect such changes in the plant: it can be difficult to determine an effective schedule for such re-training, and the re-training process introduces additional costs, as well as the risk that seasonality and other variables may not be properly captured in the process of re-training these models.

In summary, predictive methods may be used to enhance the performance, efficiency, and maintenance of chilled water plants. However, there are obstacles to the commercial application of machine-learning and other predictive methods to chilled water plants, including:
High cost to acquire a suitable model of the plant;
Availability of the required skills in the workforce that supports these plants;
Variety in the plant equipment, plumbing, controls, sensors, etc. that make it necessary to tailor predictive models to each plant;
Limited availability of useable training data; and
Ongoing cost, and complexity to re-train predictive models as the plant ages, equipment is maintained, replaced or upgraded.

Accordingly, it would be beneficial to mitigate these obstacles with respect to the commercial application of machine-learning and other predictive methods to chilled water plants.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to chilled water plant and more particularly to the control of chilled water plant.

In accordance with an embodiment of the invention there is provided a method comprising: establishing a trained model in execution upon a computer system for controlling part of a plant system relating to at least one of control of an environment and control of an aspect of the environment;
executing a change detection process upon another computer system to determine whether a change of a parameter associated with the at least one of the plant system and the environment has exceeded a defined threshold; and
upon determining the change of the parameter associated with the at least one of the plant system and the environment has exceeded the defined threshold executing a model update process.

In accordance with an embodiment of the invention there is provided a method comprising establishing a trained model in execution upon a computer system for controlling part of a plant system relating to at least one of control of an environment and control of an aspect of the environment;
the trained model employs one or more sub-models where each sub-model relates to at least one of an unknown parameter of the plant system and a bounding parameter of the system and employs a Bayesian linear regression model; and
each unknown parameter is established through an online Bayesian learning process with the trained model.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a two-dimensional Gaussian probability density function shown for two covariates.

FIG. 2 illustrates a model used to make a prediction with confidence intervals according to an embodiment of the invention.

FIGS. 3A and 3B depict the change-detection and distribution broadening techniques showing a system according to an embodiment of the invention adapting to the changes more quickly than prior art solutions.

FIG. 4 is the architectural diagram of the system.

FIG. 5 illustrates a process flow for selecting model priors, initializing, and updating model parameters of a given sub-model according to an embodiment of the invention.

### DETAILED DESCRIPTION

The present invention is directed to chilled water plant and more particularly to the control of chilled water plant.

A “portable electronic device” (PED) as used herein and throughout this disclosure, refers to a wireless device used for communications and other applications that requires a battery or other independent form of energy for power.

A “fixed electronic device” (FED) as used herein and throughout this disclosure, refers to a wireless and/or wired device used for communications and other applications that requires connection to a fixed interface to obtain power.

A “server” as used herein, and throughout this disclosure, refers to one or more physical computers co-located and/or geographically distributed running one or more services as a host to users of other computers, PEDs, FEDs, etc. to serve the client needs of these other users or executing services directly.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices.

An “artificial intelligence system” (referred to hereafter as artificial intelligence, AI) as used herein, and throughout disclosure, refers to machine intelligence or machine learning in contrast to natural intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

An “unknown parameter” as used herein refers to, but is not limited to, a parameter or variable established from applying one or AI and/or ML processes to data relating to an item or system of plant, such as water chiller plant.

The invention consists of a system for acquiring data, performing computations, and a method for learning a model of a chiller plant using online Bayesian linear regression. The invention models chiller plants, with sub-models for each major component (hydraulics, cooling tower, chiller power, etc.), using online Bayesian learning to acquire unknown parameters from data and continuously adapt to system changes without the need for re-training. The invention overcomes several obstacles to applying Bayesian linear regression to chiller plants by formulating the mathematical models as linear in the unknown parameters, bounding parameters, and detecting and adapting to changes in the data generating process. It relies on physics, engineering, and mathematical modelling for the structure of each sub-model and uses prior information that is obtained from the equipment manufacturers along with exact Bayesian inference to estimate the value of unknown coefficients. It updates model parameters sequentially as data is acquired. Such a process is intended to facilitate the identification of control variables that optimize a cost function, such as total plant energy consumption, greenhouse gas emissions, utility bills, among others.

The following embodiments and aspects thereof described and illustrated in conjunction with the systems, tools, and methods are meant to be exemplary and illustrative, not limiting in scope. In various embodiments, the above describes problems that have been reduced or eliminated, while other embodiments are directed to other improvements.

This invention is a method for modelling chiller plants, with sub-models for each major component, including hydraulics, cooling towers, and chillers, among others, using online Bayesian learning to acquire unknown parameters from data and continuously adapt to system changes without the need for re-training. The invention overcomes several obstacles to applying Bayesian linear regression to chiller plants by formulating the mathematical models as linear in the unknown parameters, bounding parameters, and detecting and adapting to changes in the data generating process. It relies on physics, engineering, and mathematical modelling for the structure of each sub-model and uses prior information that is obtained from the equipment manufacturers along with exact Bayesian inference to estimate the value of unknown coefficients. It updates model parameters sequentially. Notable features of the invention include:

Many machine learning-based solutions require a cumbersome and costly infrastructure for training, evaluating, and re-training models including computer servers and dedicated engineers. This invention sequentially updates model parameters as data is acquired and does not need human intervention in most cases. Furthermore, because it learns continuously, gradual changes in the underlying data distribution, such as those that may be caused by the change of seasons for an HVAC system, system degradation, or routine maintenance at the plant, do not invalidate the model or trigger a model re-training. This means that it is far less costly and labor intensive to monitor and validate the system once it is launched.

The structure of the models is informed by physics and engineering principles and contain only a few parameters. This provides explainability that allows engineers to understand the meaning of parameters and to recommend meaningful interventions based on well-grounded interpretations of parameter values. Furthermore, due to the small number of parameters and highly structured models, the behavior of the models is constrained and thus reliable, unlike many modern machine learning approaches.

Bayesian learning provides a principled way to estimate uncertainty and to incorporate knowledge via prior distributions. These are two invaluable features that most approaches do not have.

To perform Bayesian linear regression, all models are formulated to be linear in the unknown parameters, without substantial loss in performance compared to other state-of-art approaches in the literature.

This invention can constrain learned parameter values within a region deemed feasible by the problem's physics and engineering, thereby providing additional reliability.

In Bayesian learning, after enough evidence is accumulated, a distribution can become so narrow that it assigns near-zero probability to all other points in parameter space. If this happens, and a change occurs in the system, the Bayesian updating is unable to adapt quickly. The invention includes a mechanism to detect changes in the data generating process that is based on state-of-the-art scientific literature. If such a change is detected, the invention broadens the learned posterior distributions, which become priors to the following update. This retains the mean of the distribution, but increases the uncertainty of the estimated distribution, thus allowing the distributions to update to new values more rapidly.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Throughout the following description specific details are set forth in order to provide a more thorough understanding to persons skilled in the art. However, well known elements may not have been shown or described in detail to avoid unnecessarily obscuring the disclosure.

The term ‘Chiller Plant’ refers to a system that controls a portion of the equipment infrastructure for a facility. This may refer to a Building Automation System that controls an entire HVAC system, or it may refer to a system that controls an industrial chiller plant in a factory, ice arena, or other commercial/industrial application that requires a cooling environment.

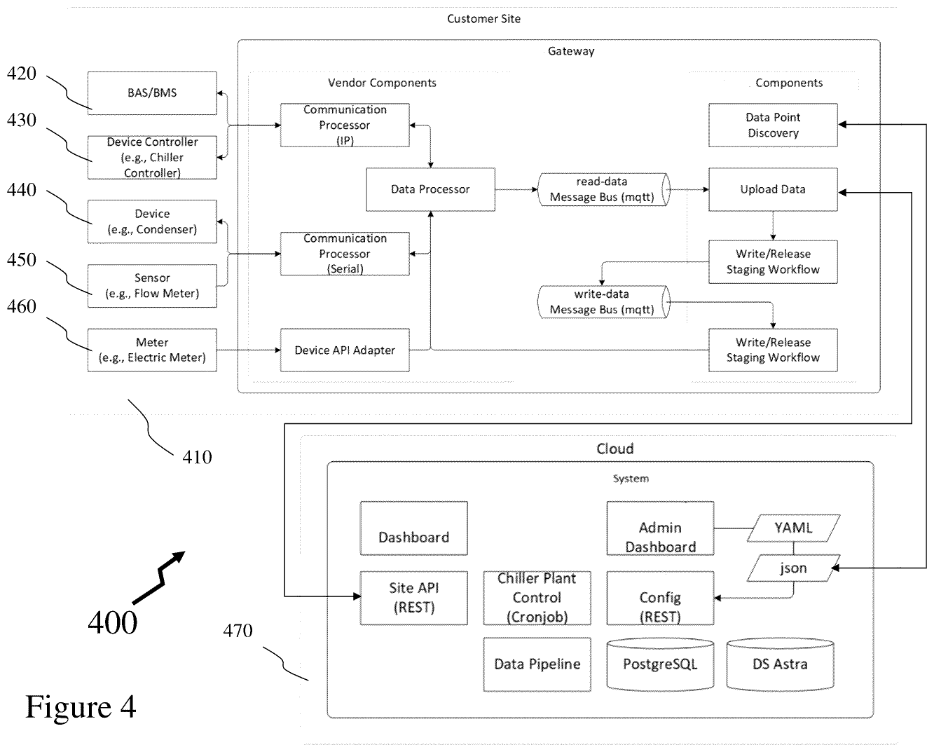

This invention consists of a system for acquiring data and performing computations, illustrated in FIG. 4., and a method for learning a model of a chiller plant using online Bayesian linear regression.

The invention uses a series of models that are used to predict the behavior of the chiller plant when given information about external weather conditions, such as but not limited to, wet bulb temperature, and control inputs. It uses online Bayesian inference to acquire all parameters that characterize the specifics of a particular chiller plant. The invention is intended to be used as a system model for chiller plants primarily for, but not limited to, the optimization of control inputs relative to a cost function, such as total plant power consumption.

To estimate the power consumption of the entire chiller plant for a particular set of control values, models are needed to evaluate the power consumption of all the system's components. This means that there are power models for the cooling tower fans, the condenser pumps, the chilled water pumps, and the chillers.

For the pumps and fans, the well-known power affinity law states that the power of a fan or pump is proportional to the cube of the fluid volume flow rate. Another affinity law states that the pump or fan speed is directly proportional to the fluid flow rate. Using these together, the power is modelled as the cube of the fan or pump speed, with unknown coefficients that are learned. The chiller power is modelled using the Gordon-Ng model with unknown coefficients. Manufacturer data is used to inform the prior distributions for all parameters.

The hydraulic networks, both on the condenser and chilled water sides of the plant, need to be modelled to predict the flow rate through each piece of equipment for a given set of controls. This means modeling both the head-flow characteristics of the pumps and the system head characteristics of the chilled water and condenser water loops. Setting these two models equal allows us to solve for the flow rates and pressure drops in all branches of the loops. The hydraulics models include unknown parameters that must be learned. The parameters are bounded to prevent unreasonable values that would correspond to unphysical results. The heat rejection, for example, at the cooling tower is modelled with a novel, single parameter model.

Below is a list of models that can be acquired and dynamically adjusted without human intervention. There are 12 model types, but there will need to be many instances of these model types to enable model predictive controls, or other advanced plant control techniques. For instance, in a chilled water plant with 3 chillers, 3 cooling towers, 4 condenser pumps, one heat exchanger, and 4 chilled water pumps, 40 models would be required.
Chiller power model
Cooling tower fan power model
Condenser pump power model
Condenser pump head-flow model
Condenser pump efficiency-flow model
Chilled water pump power model (cubic polynomial)
Chilled water pump head-flow model
Chilled water pump efficiency-flow model
Cooling tower heat rejection model
Condenser loop system head model
Chilled water loop system head model
Heat exchanger model

For each model, online Bayesian regression is used to update the unknown model parameters. Off-the-shelf Bayesian linear regression suffers from several limitations that this invention overcomes to successfully apply it to learn a system model for chiller plants for control purposes. Such limitations include the inability to place bounds on parameter values, and the risk of the posterior becoming too narrow and thus unable to adapt to changes in the data-generating process. Furthermore, to perform exact Bayesian linear regression, all models must be formulated as linear in the unknown parameters. This invention formulates all models as linear, either by construction or through approximation, while maintaining sufficient performance for use cases including optimization.

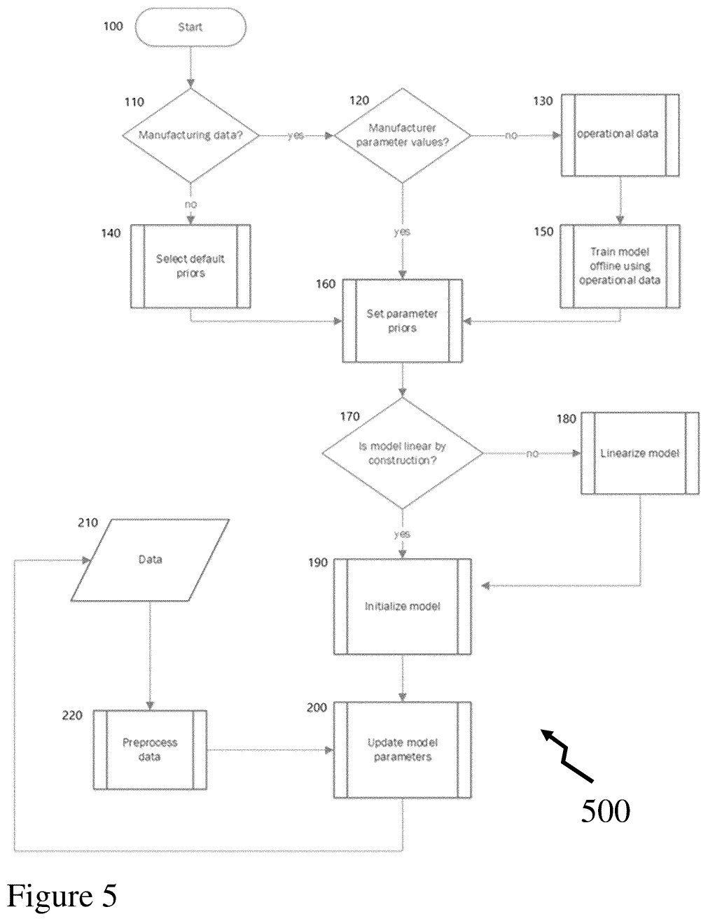

Prior distributions informed by available data such as that provided by equipment manufacturer manual's, engineering literature, and engineering expertise are placed on each parameter. If the manufacturer provides parameter values that are consistent with how the equipment is modelled, these parameter values are used directly to inform the parameter priors. If parameter values are not available directly but operational data is available from the manufacturer, the model is trained off-line on the operational data, and the acquired parameter values are used to set the priors. In the case that no manufacturer data is available, default priors are used. This process flow is illustrated in FIG. 5.

Given the limited number of parameters and the well-informed priors, the models exhibit reasonable behavior with very limited data. The invention does not need to wait to accumulate data before training in batch but rather begins training sequentially on the data immediately upon receiving it. This cuts down dramatically on the time it takes for initial deployment of the system, as compared to many data hungry machine learning approaches that must wait until a substantial amount of data is accumulated before training.

The result of each model update, given by the posterior distribution, becomes the prior distribution for the next update, allowing the models to continuously learn while online, adapting to the details of the plant without requiring arbitrary hyperparameters determining when they can update.

Models are formulated to be linear in the parameters, if possible. This, with conjugate priors on the parameters, allows for exact Bayesian updating without sampling or approximation. Exact Bayesian inference is both more accurate and much faster than approximation methods, making it suitable for application in an online setting. For models that are not linear in by construction, the invention linearizes with respect to parameters. When available, the equations are linearized around parameter values from manufacturing data or models learned off-line. In other cases, the invention learns a zeroth-order term based on a reasonable assumption that simplifies the equations. To illustrate the idea, one can imagine a hydraulics model, where there is a flow-split between multiple pieces of equipment. The invention can make an equal flow-split assumption between the equipment as a zeroth-order term and linearize around the parameter values that are obtained. In all cases of linearization, the model learns a linear correction to the zeroth-order term online. This process is shown as a step in FIG. 5 before model initialization (step 100 up to Step 190).

Many machine learning techniques assume that the data is independent and identically distributed (iid). In the case of time-series data, like those typically dealt with in the context of chiller plant optimization, there may be drift, or change, in the distribution over time as data is acquired. This can arise from maintenance to the plant or equipment degradation, for example. In many applications, this would require a re-training of the model. This is not the case for online Bayesian learning because the system updates the parameter distributions at every data point and can continuously adapt in most cases.

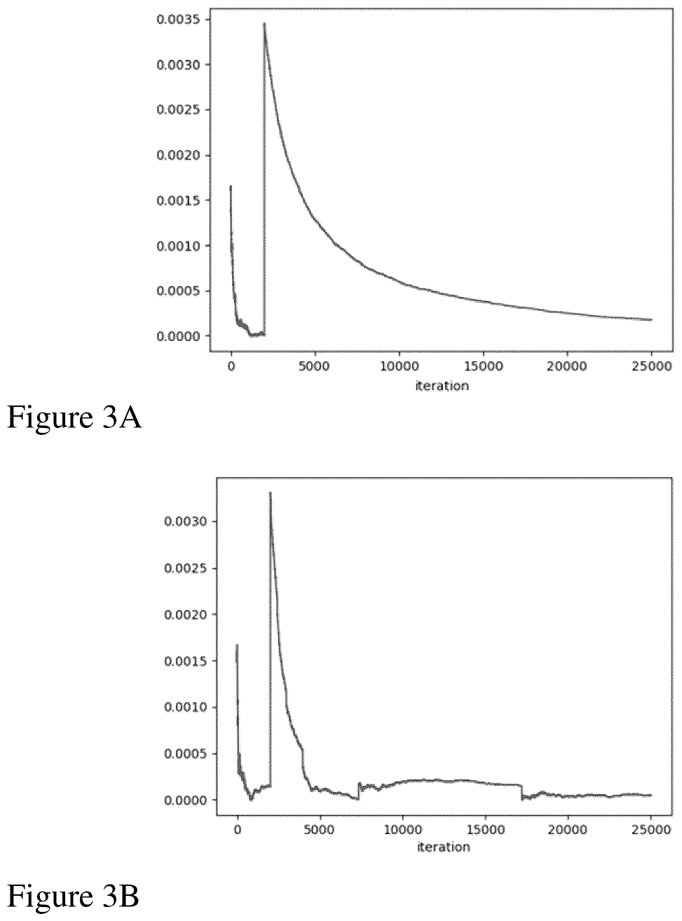

In rare cases, given enough data, the posterior distribution can become so narrow that it collapses to a single point. This means that the model is highly confident that the value it has acquired is the correct one and that there is virtually no probability outside of a narrow region surrounding this value. If such a collapse occurs and the data-generating process subsequently undergoes a change, such as those mentioned previously, the Bayesian learning may not be able to adapt sufficiently. To address this shortcoming, the invention uses a change-point detection mechanism that utilizes variational inference as described in \cite {Li et al}. If a change-point is detected, the invention increases the variance of the estimated parameter distribution to allow the subsequent updates to adapt more quickly. This does not change the mean of the distribution and can be thought of as increasing the uncertainty of the model. This increase in certainty allows the distribution to adapt more quickly because it gives higher probability to regions away from the current estimate. This can be seen in FIG. 3. This feature automates a key and costly component of what typically falls into the realm of machine learning operations (ML Ops), in which dedicated engineers monitor model performance and initiate re-training based on a variety of model metrics and hyperparameters.

Typically, exact Bayesian inference does not allow the user to set hard constraints on the parameters. For robustness and reliability, the invention imposes bounds on the values that the parameter can hold. It uses physics and engineering principles to set these bounds. The bounds are enforced by finding the set of parameters that maximizes the learned multivariate distribution within the bounds (see FIG. 1). This, in effect, corresponds to choosing the most probable parameter setting that is consistent with the bounds. This feature enables the invention to impose crucial constraints on the behavior of the models that are learned. This improves safety and robustness for control frameworks that utilize the invention as system model.

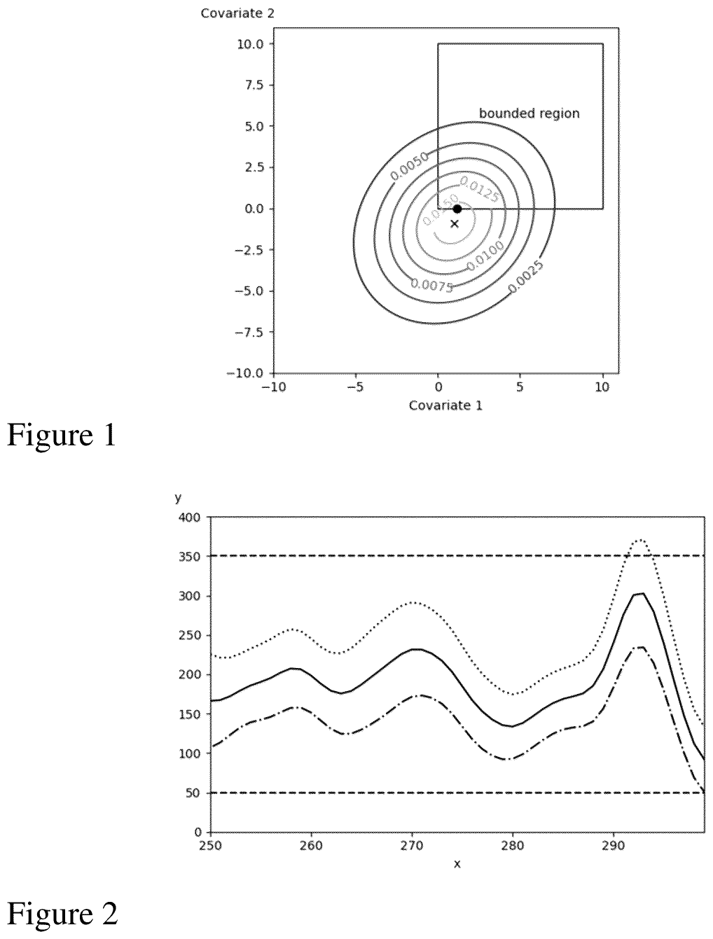

By utilizing Bayesian learning, in which parameter estimations are represented by probability distributions, it is possible to quantify the uncertainty of parameter estimates and model predictions. The uncertainty can inform many aspects of a control framework. One such case pertains to constraints. Uncertainty estimates allow for the invention to account for model uncertainty when treating constraints, providing a layer of safety that is not typically available in such frameworks. This idea is illustrated in FIG. 2. Many competing approaches cannot quantify uncertainty and thus either incorrectly characterize their ability to respect constraints or introduce arbitrary buffers to protect against constraint violation. Bayesian uncertainty quantification provides a principled way to accurately respect constraints, and even allow for user-defined risk tolerances based on the probability of violating a constraint.

Referring to FIG. 1 there is depicted a two-dimensional Gaussian probability density function is shown for two covariates. Acceptable values of the parameters are confined to the bounded region. The probability density function is maximized within the bounded region to obtain the point deemed “maximum within bounds”. Without the bounds, the maximum would be the point represented by an “x”, called “maximum.” This figure demonstrates how the maximum value of the posterior may lie outside of the bounded region, but another point with probability almost as high as the maximum value can be chosen to satisfy constraints. By constraining the parameters that can be learned, the invention achieves additional robustness, reliability, and safety and prevents unwanted behavior.

Now referring to FIG. 2 there is depicted a model employed to make a prediction with confidence intervals for the quantity “y.” Safe values for the quantity “y” lie between the lower and upper constraints (identified by the heavy dashed line at 50 and 350 respectively), shown in the figure. The figure demonstrates a crucial benefit of the confidence intervals provided by the invention. The model can provide model uncertainty (as illustrated by the dashed lines just above and below the solid line of the mean prediction) and thereby estimate the likelihood of violating a constraint. The invention can thus account for model uncertainty in constraint consideration, and even allow for user-defined risk tolerances for control applications.

Referring to FIG. 3A there is depicted the difference between the true value of a parameter (R_{TRUE}) and a prior art model (R_{ACQUIRED}) plotted as a function of the number of iterations where the prior art model uses regular Bayesian linear regression. The curve falls towards zero as the accuracy of the model improves. The data-generating process is then changed at iteration 2000, such that the new true value of R is different. This leads to a large spike in the error. The model slowly starts to recover and learn the new value, and the curve tends back toward zero.

In contrast referring to FIG. 3B there is depicted the result of the same test where the model employed employs change-detection and distribution broadening techniques according to embodiments of the invention. As evident in FIG. 3B the system according to an embodiment of the invention adapts to the change in the value of R much more quicky.

Now referring to FIG. 4 there is depicted an exemplary architectural diagram of a System 400 that enables embodiments of the invention. The Gateway 410 component of the System 400 receives information directly from the Building Automation System(s)/Building Management System(s) (BASs/BMSs) 420, Device Controllers 430, Devices 440, Sensors 450, and/or Meters 460 as available via appropriate communication components (such as but not limited to Internet Protocol (IP) Communication Processors, Serial Communication Processors, and Device Application Programming Interface (API) Adapters). The received data is uploaded to a Cloud 470 which performs system flow process as detailed in FIG. 5 for example.

FIG. 5 depicts a Flow 500 of a process according to an embodiment of the invention that a system according to an embodiment of the invention employs to select model priors, initialize the system, and update model parameters of a given sub-model. The process Starts (step 100) in Step 110, identifying if there is manufacturing data available or not. If there is data available, then a check is made, Step 120, to determine if they are parameter values or operational data.

If there is no manufacturing data available, as determined in Step 110, then the system would select default priors in Step 140 and proceed to setting the parameter priors in Step 160. Default priors are determined based on what is known about the chiller plant combined with generic engineering principles. If there is manufacturing data available and it is parameter values, as determined via Steps 110 and 120, then the system would proceed to setting the parameter priors in Step 160.

If there is manufacturing data available and it is not parameter values, as determined via Steps 110 and 120, then the system would retrieve the operational data and train the model offline Step 150 using this retrieved operational data. Once the model was trained, the system would set the parameter priors in Step 160. Once the parameter priors are set in Step 160, the system will determine if the model is linear by construction. If the model is not linear, then the system will linearize the model in Step 180. Once the model is linearized, then the system will Initialize the model in Step 190. If the model is linear Flow 500 proceeds directly to Step 190 from Step 170. From Step 190 Flow 500 proceeds to Step 200 wherein the system will update the model parameters. If the Steps 210 and 220 are repetitive steps in that the system will receive data from the chiller plant, performing preprocessing on the data, and update the model parameters. These steps (200, 210, 220) will be iterated each time the system receives new data from the chiller plant (see FIG. 4).

An exemplary system according to an embodiment of the invention such as described and depicted with respect to FIGS. 4 and 5 updates all the sub-models in parallel (in a looping process). Once all the data models has been initialized, the system queries the database for the most recent data (Step 210), performs integrity checks on the data (Step 220), runs the changepoint detection (Step 220) and resets the posterior distribution if a changepoint is found (Step 220), then updates the posterior using exact Bayesian inference for each sub-model (Step 200).

Within an alternate embodiment of the invention if there is manufacturing data available and it is parameter values, as determined via Steps 110 and 120, then the system may proceed to setting the parameter priors in Step 160 via an intermediate step of training another model based upon the manufacturing data available.

Within an alternate embodiment of the invention if there is manufacturing data available, as determined in Step 110, then it may be retrieved and the parameter values employed in conjunction with retrieved operational data and train the model offline Step 150 using this retrieved operational and manufacturing data.

Within the preceding description a system, e.g., System 400 in FIG. 4, is described comprising elements, such as Gateway 410, BAS/BMS 420, Device Controllers 430, Devices 440, Sensors 450, Meters 460 and Cloud 470. The Gateway 410, BAS/BMS 420 and Cloud 470 may each be an application in execution upon a PED, FED or server or a physical device such as a PED, FED or server for example. Likewise, Device Controllers 430, Devices 440, Sensors 450 and Meters 460 may each be applications executing upon a PED, FED or server or a physical device such as a PED, FED or server for example. Each of the Device Controllers 430, Devices 440, Sensors 450 and Meters 460 may be instantiated discrete from an element of the chilled water plant and receive data from the chilled water plant or be integral with an element of the chilled water plant.

Whilst the foregoing disclosure is described and depicted with respect to chilled water plant it would be evident that the embodiments of the invention may be applied to other plant systems such as air conditioning system, heating systems, lighting systems, ventilation systems, and heating, ventilation and air conditioning (HVAC) systems for example.

Accordingly, within embodiments of the invention a model is established which receives inputs relating to one or more aspects of the operation of the plant system or an environment with which the plant system is associated and establishes one or more outputs where each output relates to a setting of one or more elements of the plant system to established a target state of the plant system and/or the environment.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g., software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing a trained model in execution upon a computer system for controlling part of a plant system relating to at least one of control of an environment and control of an aspect of the environment;
executing a change detection process upon another computer system to determine whether a change of a parameter associated with the at least one of the plant system and the environment has exceeded a defined threshold; and
upon determining the change of the parameter associated with the at least one of the plant system and the environment has exceeded the defined threshold executing a model update process.

2. The method according to claim 1, wherein
the trained model employs one or more sub-models where each sub-model:
relates to at least one of an unknown parameter of the plant system and a bounding parameter of the system; and
employs a Bayesian linear regression model; and
each unknown parameter is established through an online Bayesian learning process with the trained model.

3. The method according to claim 1, wherein
the trained model is established in dependence upon at least one of manufacturing data and operational data relating to elements of the plant system; and
prior to an initialization of the trained model to control the at least one of the plant system associated with the environment and the aspect of the environment the trained model is analyzed to determine if it is linear;
upon a determination that the trained model is not linear a further step of linearizing the trained model is performed prior to initialization of the trained model.

4. The method according to claim 1, wherein
executing the model update process comprises:
broadening one or more learned distributions of the trained model whilst maintaining for each learned distribution of the one or more learned distributions the mean of that learned distribution; and
re-initializing the trained model with the new broadened one or more learned distributions; and
each learned distribution relates to one or more parameters of the plant system.

5. The method according to claim 1, wherein
the trained model employs a number of sub-models where each sub-model:
relates to at least one of an unknown parameter of the plant system and a bounding parameter of the system; and
employs a Bayesian linear regression model;
each unknown parameter is established through an online Bayesian learning process with the trained model; and
where a sub-model of the number of sub-models relates to an unknown parameter of the plant system the sub-model of the number of sub-models is formulated as linear by at least one of construction and approximation for the unknown parameter of the plant system.

6. The method according to claim 1, wherein
the trained model upon installation upon the computer system begins training immediately by employing data received by the computer system relating to the plant system;
the trained model is periodically updated where a set of current distributions for a current update of the trained model become training data distributions for the next update of the trained model such that the trained model continuously learns whilst online controlling the plant system; and
each current distribution of the set of current distributions relates to at least one of control parameter of the plant system and an aspect of the environment.

7. The method according to claim 1, wherein
the trained model upon installation upon the computer system begins training immediately by employing data received by the computer system relating to the plant system;
the trained model is periodically updated where a set of current distributions for a current update of the trained model become training data distributions for the next update of the trained model such that the trained model continuously learns whilst online controlling the plant system;
each current distribution of the set of current distributions relates to at least one of control parameter of the plant system and an aspect of the environment; and
the set of current distributions for the trained model at installation are established by a number of process iterations are performed where each process iteration comprises:
determining whether data relating to parameter values of an element of the plant system is available from a manufacturer of the element of the plant system;
upon a positive determination that the data is available retrieving the data;
upon retrieving the data determining whether the data from the manufacturer comprises parameter values consistent with how the trained model models the plant system;
upon determining the retrieved data is consistent with how the trained model models the plant system using this data to establish the parameters of the trained model for that element of the plant system and stopping this iteration of the process;
upon determining the retrieved data is not consistent with how the trained model models the plant system determining whether operational data is available from the manufacturer of the element of the plant system;
upon determining that the model models the plant system determining whether operational executing an initial off-line training process for that element of the plant system with the operational data to establish the parameters of the trained model for that element of the plant system and stopping this process iteration;
employing default parameters of the trained model for that element of the plant system; and
for each process iteration of the process the element of the plant system is a different physical element of the plant system.

8. A method comprising:
establishing a trained model in execution upon a computer system for controlling part of a plant system relating to at least one of control of an environment and control of an aspect of the environment;
establishing a trained model in execution upon a computer system associated with a plant system relating to at least one of control of an environment and an aspect of the environment; wherein
the trained model employs one or more sub-models where each sub-model relates to at least one of an unknown parameter of the plant system and a bounding parameter of the system and employs a Bayesian linear regression model; and
each unknown parameter is established through an online Bayesian learning process with the trained model.

9. The method according to claim 8, further comprising
executing a change detection process upon another computer system to determine whether a change of a parameter associated with the at least one of the plant system and the environment has exceeded a defined threshold; and
upon determining the change of the parameter associated with the at least one of the plant system and the environment has exceeded the defined threshold executing a model update process.

10. The method according to claim 8, wherein
the trained model is established in dependence upon at least one of manufacturing data and operational data relating to elements of the plant system; and
prior to an initialization of the trained model to control the at least one of the plant system associated with the environment and the aspect of the environment the trained model is analyzed to determine if it is linear;
upon a determination that the trained model is not linear a further step of linearizing the trained model is performed prior to initialization of the trained model.

11. The method according to claim 8, further comprising
executing a change detection process upon another computer system to determine whether a change of a parameter associated with the at least one of the plant system and the environment has exceeded a defined threshold; and
upon determining the change of the parameter associated with the at least one of the plant system and the environment has exceeded the defined threshold executing a model update process which comprises:
broadening one or more learned distributions of the trained model whilst maintaining for each learned distribution of the one or more learned distributions the mean of that learned distribution; and
re-initializing the trained model with the new broadened one or more learned distributions; and
each learned distribution relates to one or more parameters of the plant system.

12. The method according to claim 8, wherein
the trained model employs a number of sub-models where each sub-model:
relates to at least one of an unknown parameter of the plant system and a bounding parameter of the system; and
employs a Bayesian linear regression model;
each unknown parameter is established through an online Bayesian learning process with the trained model; and
where a sub-model of the number of sub-models relates to an unknown parameter of the plant system the sub-model of the number of sub-models is formulated as linear by at least one of construction and approximation for the unknown parameter of the plant system.

13. The method according to claim 8, wherein
the trained model upon installation upon the computer system begins training immediately by employing data received by the computer system relating to the plant system;
the trained model is periodically updated where a set of current distributions for a current update of the trained model become training data distributions for the next update of the trained model such that the trained model continuously learns whilst online controlling the plant system; and
each current distribution of the set of current distributions relates to at least one of control parameter of the plant system and an aspect of the environment.

14. The method according to claim 8, wherein
the trained model upon installation upon the computer system begins training immediately by employing data received by the computer system relating to the plant system;
the trained model is periodically updated where a set of current distributions for a current update of the trained model become training data distributions for the next update of the trained model such that the trained model continuously learns whilst online controlling the plant system;
each current distribution of the set of current distributions relates to at least one of control parameter of the plant system and an aspect of the environment; and
the set of current distributions for the trained model at installation are established by a number of process iterations are performed where each process iteration comprises:
determining whether data relating to parameter values of an element of the plant system is available from a manufacturer of the element of the plant system;
upon a positive determination that the data is available retrieving the data;
upon retrieving the data determining whether the data from the manufacturer comprises parameter values consistent with how the trained model models the plant system;
upon determining the retrieved data is consistent with how the trained model models the plant system using this data to establish the parameters of the trained model for that element of the plant system and stopping this iteration of the process;
upon determining the retrieved data is not consistent with how the trained model models the plant system determining whether operational data is available from the manufacturer of the element of the plant system;
upon determining that the model models the plant system determining whether operational executing an initial off-line training process for that element of the plant system with the operational data to establish the parameters of the trained model for that element of the plant system and stopping this process iteration;
employing default parameters of the trained model for that element of the plant system; and
for each process iteration of the process the element of the plant system is a different physical element of the plant system.
